(19) United States
(12) Patent Application Publication
(10) Pub. No.: US 2003/0105562 A1
(43) Pub. Date: Jun. 5, 2003

(54) Power output control system for electric vehicle with hybrid fuel cell

(75) Inventors: Jui-Sheng Hsiao, Hsinchu (TW); Chien-Tsung Wu, Hsinchu (TW); Chi-Tang Hsu, Hsinchu (TW); Jin-Chyuan Hung, Hsinchu (TW); Ping-Huei Shu, Hsinchu (TW)

Correspondence Address: DOUGHERTY & TROXELL, SUITE 1404, 5205 LEESBURG PIKE, FALLS CHURCH, VA, 22041, US

(73) Assignee: Industrial Technology Research Institute

(21) Appl. No.: 09/997,010

(22) Filed: Nov. 30, 2001

(51) Int. Cl. B60L 11/00

(52) U.S. Cl. 701/22; 180/65.3

(57) ABSTRACT

The present invention is a power output control system for electric vehicle with hybrid fuel cell, which is an optimal design of DC/DC converter and applies the controller area network (CAN) as a connected instrument for communication to make a power source tend to be more flexible. When the invention is designed in the states of medium and low loads (for example, cruise in constant speed), the main electric energy supplied by the fuel cell boosts the fuel cell to an appropriate voltage through the control of DC/DC converter. While in the state of high load (for example, transient acceleration or uphill creep), the fuel cell may be served as an on-board charger. Not only the fuel cell may provide a maximum base load of electric power, but also the remaining requirement of electric energy is matched with the additional output of electric energy supplied by a high power secondary battery. So, the fuel cell of the invention is made to have the control function of compound power output and be able to effectively improve the shortcomings of the small electric vehicle of prior arts, such as: insufficient distance for sustaining cruise and inferior conversion of energy. In addition, compared with the power source of a full fuel cell, the power source used in both hybrid fuel cell and high power secondary battery not only has lower cost but also further has the advantage of making the system easy to match during choosing a fuel cell. When the invention is applied in various types of electric vehicles, it may make the system have an excellent ability of sustaining cruise.

### 1. FIELD OF THE INVENTION

The present invention relates to a power output control system for electric vehicle with hybrid fuel cell, especially to a power source control system for electric vehicle with hybrid electric energy that through the interface communication of a Controller Area Network (CAN) integrates an optimal design from a DC/DC converter and several power sources, such as: polymer electrolyte membrane fuel cell, and secondary battery, etc. to make the power system maintain in a preferable state of operation.

### 2. BACKGROUND OF THE INVENTION

Accordingly, during long term, motorcycle has always been a major transportation vehicle in Taiwan. Because it has the characteristics of lightweight, less fuel consumption and easy parking, motorcycle almost becomes a necessary vehicle of transportation for every family. But, in recent years, the ideology of environmental protection has been coming up, because the concentrations of carbon monoxide and hydrocarbon are raising up and have seriously destroyed the structure of atmospheric layer. Therefore, there are strict standards of emission gas regulated for all motorcars and motorcycles. Motorcycle with four strokes has preferable standard of emission gas, so it gradually replaces the motorcycle with two strokes to become a main stream in current market. Nowadays, the further strict standards of emission gas for the third term and fourth term of environmental protection are ready to carry out, but the ultimate goal of the environmental protection is to make the motorcar and motorcycle reach the standard of zero pollution.

In order to reach above objects, thus, the motorcar and motorcycle that do not use gasoline as fuel have already been developed out in current market. In stead of traditional engines, they use chargeable lead-acid battery as a source of electric energy, so they may reach the standard of zero pollution, but their ability of sustaining cruise is poor (they can only be driven for 60 kilometers after being completely charged), also there are shortcomings existed, such as: long time of charging (it takes about eight hours), and scarce station for charging, etc. Therefore, the relative enterprises can not promote this kind of vehicle effectively and it is resulted that the purchasing willing of the consumer is low. The present invention that develops an innovative control system for power output may make the electric vehicles (for example, motorcycle and bicycle, etc.) have a better ability of sustaining cruise, so the present invention is indeed an improvement for the electric motorcycle of the prior arts.

Furthermore, the polymer electrolyte membrane fuel cell (PEMFC) is the most fast development of fuel cell in recent years, in comparing with other kinds of fuel cell, the polymer electrolyte membrane fuel cell has the merits of fast starting in room temperature and sensitive transient response. In the future, the PEMFC may be widely applied on the portable power system of motorcycle and motorcar, etc. The PEMFC adopts the hydrogen of fuels and oxygen from the air to make a reaction procedure similar to the phenomenon of a reverse reaction of electrochemistry. During the procedure of this reaction, besides the generation of electric power, it also generates waste heat but without producing any poisonous material, so the PEMFC is an optimal choice of clean energy for vehicle.

The properties of the electricity discharge of the PEMFC are dependent on the properties of its membrane electrode assembly (MEA). Influences will be generated from following all factors:

(1)In the interior of the gas diffusion layer: the number, the shape, the thickness, the drainage, and the conductivity of the hole of the MEA all will generate influence.

(2)In the interior of the operation layer: the species, the component of catalyst, the content of precious metal, the magnitude and distribution situation of crystalline grain all will generate influence.

(3)In the interior of the proton exchanging film: the thickness, the water content, the hole structure, the magnitude and number of the hole all will generate influence.

Please refer to FIG. 1, which is a characteristic (electricity discharge characteristic) curve figure for “current density vs. voltage” of the polymer electrolyte membrane fuel cell of the prior arts and is also called as a polarization curve or a Tafel curve that is a performance of electricity discharge when a typical polymer electrolyte membrane fuel cell reacts. Under the standard circumstances of the room temperature (25° C.), when one mole of water is generated, the enthalpy (ΔH⁰) of −286 kJ/mole may be converted to a Gibbs free energy (ΔG⁰) of electric energy of −237 kJ/mole. Therefore, the theoretical efficiency of electric energy only reaches 83% and the remaining −49 kJ/mole (−TΔS⁰) is released out as waste heat. In comparing with the traditional engine such as internal combustion engine, the polymer electrolyte membrane fuel cell possesses an higher efficiency of energy conversion due to this kind of electrochemistry reaction at room temperature. The characteristics of electricity discharge may be found out from the polarization curve as following:

Zone A: when the fuel cell outputs low density of current, influenced by the loss of activation, the voltage value can not reach the theoretical value of 1.23V at zero current (no load); when outputting small current density, the voltage decreases rapidly and apparently shows a non-linearity.

Zone B: the generated loss of electric energy is that the transfer of proton and electron is influenced by the internal ohm; namely, the following four important parameters: electric impedance of electrode conductor, reaction of cathode resistance, reaction of positive pole resistance, and resistance of electrolyte, etc. The voltage in this zone then decreases linearly in proportion to the increase of current density.

Zone C: the output of current density reaches a highest point and its cause of loss is that it needs more number of molecular of reactive gasses (air and hydrogen) during the occurrence of mass reaction; however, since the transfers of gas and proton are restricted by the mass transfer, so they are unable to provide the necessary number of molecular for reaction, and therefore the value of voltage decreases abruptly.

In applying the polarization curve of polymer electrolyte membrane fuel cell to the present invention, the characteristic of linear proportion for both current density and voltage matched with the appropriate communication of control means for connection between the DC/DC converter and controller area network make the invention have an excellent ability of sustaining cruise and a flexible output of power when the invention is applied in electric vehicle.

### SUMMARY OF THE INVENTION

Although the electric vehicle of the prior arts has the characteristics of low noise and no air pollution, but lots of problems are still existed: long time of charging, short time of sustaining cruise, too heavy battery (lead-acid battery), and insufficient facility for charging, etc. Therefore, the traditional electric vehicle is subjected to an extreme restriction by these problems. In order to solve the above-mentioned shortcomings of the prior arts, the main object of the present invention—an power output control system for electric vehicle with hybrid fuel cell—is to make the power source tend to be more flexible through the optimal design of a DC/DC converter and taking controller area network as a communication instrument for connection.

Another object of the present invention is to apply the PEMFC of small power as the main power source for electric vehicle and take the high power secondary battery as the auxiliary power source.

The characteristics of this kind of driving control system for electric vehicle with hybrid fuel cell are:

(1) Take the PEMFC of small power as the main electric source for normal load.

(2) Take the high power secondary battery as the electric source for transient state and peak load.

(3) Take the PEMFC as a supplementary electric source for the high power secondary battery.

(4) Through the control of the DC/DC converter, the PEMFC may adjust the power output according to the road situation and load, and the high power secondary battery may adjust the actions of electricity charge and discharge.

(5) With this manner of hybrid electric energy, the problem of slower reaction of the system of fuel cell may be solved to make the power output maintain in a best situation of working.

(6) Take the controller area network as the communication and management of electric energy for the DC/DC converter, the high power secondary battery, and the fuel cell, etc.

(7) With the mode of hybrid electric energy, taking the fuel cell as the electric source for normal load and taking the high power secondary battery as the electric source for transient state and peak load, the power output is made to be more flexible and faster to fulfill the performance requirement of power of the entire vehicle.

(8) Controlling the electric power output of the fuel cell as the usage of power and electricity charge may maintain the fuel cell operated in a more efficient and stable state, so the entire efficiency and distance of sustaining cruise are all promoted.

(9) Through the DC/DC controller, converting the output of the electric energy of the fuel cell to a more appropriate range of voltage may make the choice of a fuel cell be more flexible.

(10) If the system design and heat management are derived from the regulation minimization for the output of relative transient state and normal load, the improvement of the required system response, and in the mean time the relative lowering down of flow rate of the supplication system of the fuel (hydrogen) and air, etc., then the system design and heat management will be more easy.

(11) Minimize the fuel cell and greatly lower down the cost.

(12) Although the cost is caused to increase from the DC/DC converter, but the regulation is smaller and the increasing cost is limited since it is applied in fuel cell.

To further explain the present invention in more detail, the drawings, description of element numbers and detailed description of the invention are also presented as following in hope to benefit your esteemed review committee in reviewing this patent application.

### BRIEF DESCRIPTION OF THE DRAWINGS

FIG. 1 is a characteristic curve figure of “current density vs. voltage” of the PEMFC of the prior arts.

FIG. 2 is a characteristic curve figure of “current density vs. voltage” of the PEMFC applied in the present invention.

FIG. 3 is a structural illustration for the power output control system according to the present invention.

FIG. 4 is an embodiment for the DC/DC converter according to the present invention.

FIG. 5 is another embodiment for the DC/DC converter according to the present invention.

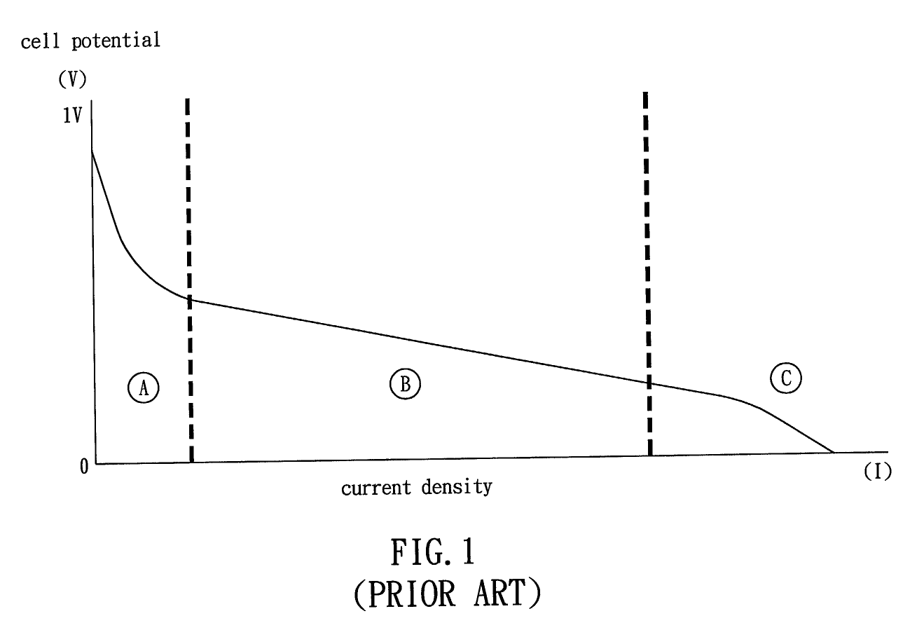

### DETAILED DESCRIPTION OF THE INVENTION

The preferable embodiments according to the present invention are described as following in corresponding to respective drawings.

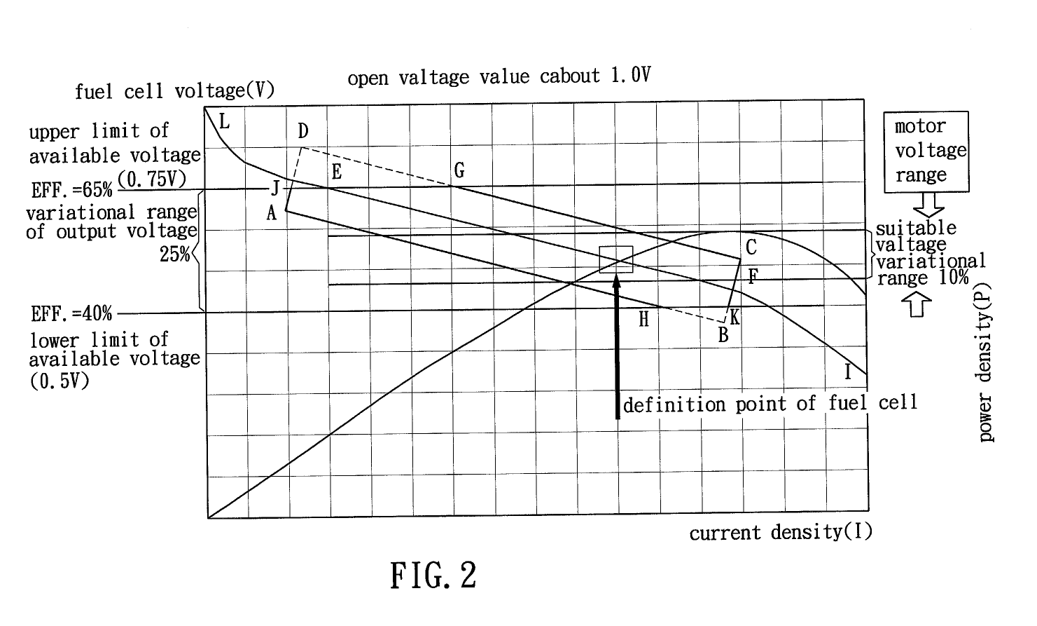

Please refer to FIG. 2, which is a characteristic curve figure of “current density vs. voltage” of the PEMFC applied in the present invention. Wherein, the PEMFC proceeds an electricity generation (the fuel cell may be regarded as a small power plant) by a reverse electrochemistry reaction of air and hydrogen. During the procedure of electricity generation, because of the entrance of fuel cell of air pressure, air temperature, dehumidifying state (humidity variation), clean level of air, and utilization rate of hydrogen, etc., the relationship between the current density and voltage of the fuel cell is shown as the zone ABCD of the figure. This is the possible variational range of the polarization curve figure. That is, under the higher supplication of air pressure, air temperature, air humidity, oxygen purity, and utilization rate of hydrogen, etc., the curve will be made to bias to the right side according to the reference line EF, so a higher output current density and higher output voltage will be obtained. This means that the output power density is increased. When biasing to the right side and the line reaches the positions of C, D, the current density at point C reaches the maximum. On the other hand, if the curve is biased to left side according to the line EF, the output current density and voltage will all be lowered down, and the output power density will be lowered down too, and the line AB could be the positions of lowest values. Furthermore, when the fuel cell is at low current density, although the voltage value (cell voltage) is higher, the voltages of the curve LE in this zone are lowered down abruptly. Under the same states, when the fuel cell is at high current density, the voltage value (cell voltage) is greatly lowered down. Therefore, the curve LE and curve FI are inappropriate to use. To maintain a constant value of power generation efficiency, the voltage value of the cell should be controlled in specific zone, of which the upper limit value is line JG and the lower limit value is line HK. In shorts, because of the variation of parameters of pressure, temperature, clean level supplied by air and the utilization rate of hydrogen, etc., the created output current density and voltage variation of the polymer electrolyte membrane fuel cell should be maintained at the specific operation zone AHKCGJ. Under the appropriate states of output current density of fuel cell, the electricity generation rate is maintained between 65%˜40%. By the DC/DC converter, the invention adjusts the output voltage of the fuel cell of wide range (25% variation) to an voltage (10% variation) suitable for the driving system of electric energy.

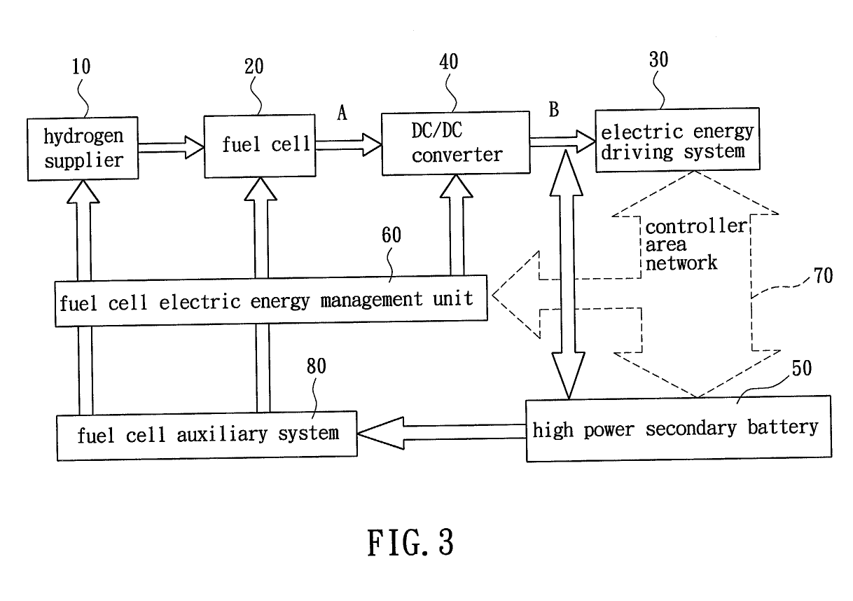

Please refer to FIG. 3, which is a structural illustration for the power output control system according to the present invention. The power output system of the electric vehicle includes:

A hydrogen supplier 10, which is used to control the supplication of fuel.

A fuel cell 20, which is a polymer electrolyte membrane fuel cell and may output an electric energy through reactive operation.

An electric energy driving system 30, which is an electric motor that takes the DC power as energy source and may output power to the transmission apparatus (not shown in the figures).

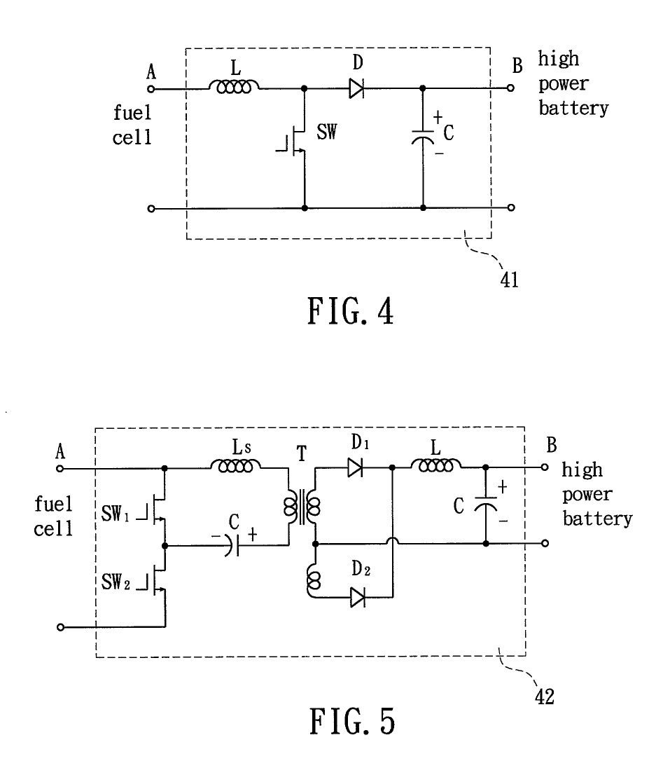

A DC/DC converter 40, which changes the voltage of the electric energy output from the polymer electrolyte membrane fuel cell and outputs it to the electric energy driving system 30 or charges a high power secondary battery 50. Please again refer to FIG. 4, which is an embodiment of the DC/DC converter according to the present invention. It is an easier structure of non-isolated DC/DC converter 41. The constituted elements in the interior includes: an inductance (L), a switch (SW, it is constituted of a field effect transistor of N-type metallic oxide semiconductor), a diode (D), and a conductance. The embodiment may proceed the charging action to the high power secondary battery 50 without transforming voltage through a transformer. Please further refer to FIG. 5, which is another embodiment of the DC/DC converter according to the present invention. It is an isolated DC/DC converter 42 with more complicated structure. Its internal structure is more complicated than that of FIG. 4. It further includes a transformer (T), by which the transformed voltage proceeds an charging action on the high power secondary battery 50.

A high power secondary battery 50, which may output an electric energy to the electric energy driving system 30.

A fuel cell electric energy management unit 60, which may control the output flow path of the electric energy to make the various equipment (such as: fan, heat exchanger, etc.) required electric energy in the electric vehicle obtain appropriate electric energy.

A fuel cell auxiliary system 80, which provides an electric energy to the auxiliary elements of an electric vehicle and makes the auxiliary elements generate motion.

Furthermore, in the interface of the controller area network 70, point A is the output point of the fuel cell. The polymer electrolyte membrane fuel cell is piled up by multiple layers of cells. Its output voltage and current density are varied according to the difference of the piling up cells. By the DC/DC converter 40, the invention proceeds the switch control on the voltage output from the fuel cell 20 in responding to the feedback of the high power secondary battery. When the output voltage is larger than the maximum allowing voltage value (0.8V) or smaller than the minimum allowing voltage value (0.5V), the DC/DC converter 40 then shuts down the voltage output from the fuel cell 20 to ensure the fuel cell 20 maintaining a constant value of electricity generation. At this time, the power of the electric vehicle is completely supplied by the fuel cell 20. Point B is the output converging point of both high power secondary battery 50 and DC/DC converter 40. Through the optimal design of the DC/DC converter 40 and the connection of interface communication of the controller area network 70, when the state of charge (SOC) of the high power secondary battery 50 is higher than 90%˜100%, the controller area network 70 then provides signals to stop the fuel cell 20 charging the high power secondary battery 50. The SOC of 80%˜90% is the limitation range of the charging action. When the SOC is 0%˜40%, the discharge is stopped. The SOC of 40%˜60% is the limitation range of the discharging action. The controlled working area is the SOC in the 60%˜80% zone.

Furthermore, the invention integrates the current and voltage of the PEMFC in the electricity generation zone of optimal efficiency. The DC/DC converter 40 is taken as a buffer for adjusting the output of the fuel cell 20, and through the interface of the controller area network 70, a signal is provided to the DC/DC converter 40 to adjust the charging and discharging action of the high power secondary battery 50. That is, when the electric vehicle of fuel cell is under peak load (such as, uphill creep or transient acceleration), the electric energy is supplied simultaneously by both output of fuel cell 20 and output of high power secondary battery 50, then it is decided if the fuel cell 20 served as on-board charger proceeds the charging job. Therefore, the fuel cell 20 may be maintained at the optimal working state. The DC/DC converter 40 may also be regarded as a regulator among the three: the power load, the high power secondary battery 50, and the fuel cell 30. The power control system of the electric vehicle of fuel cell is connected by the interface of controller area network 70, which has the characteristics of fast data transfer rates, flexibility, and easy implementation, etc. and reaches the object of optimal application of power by responding to the requirement of power load of the electric vehicle.

What is claimed is:

1. A power output control system for electric vehicle with hybrid fuel cell, which includes:
a hydrogen supplier, which is used to control the supplication of fuel;
an electric energy driving system, which is an electric motor that takes the DC power as energy source and may output power to the transmission apparatus;
a DC/DC converter, which changes the voltage and current of the electric energy output from the fuel cell and then outputs it to the electric energy driving system;
a high power secondary battery, which may output an electric energy to the electric energy driving system;
a fuel cell electric energy management unit, which may control the output flow path of the electric energy to make various equipment required electric energy in the electric vehicle obtain appropriate electric energy; and
a controller area network, which may be connected with the electric energy driving system, the high power secondary battery and the fuel cell electric energy management unit and may adjust the electric energy output within a specific range according to the requirement of load.

2. A power output control system for electric vehicle with hybrid fuel cell according to claim 1, wherein the high power secondary battery may be formed by a plurality of lithium cells connected in serials.

3. A power output control system for electric vehicle with hybrid fuel cell according to claim 1, wherein the system is further arranged a fuel cell auxiliary system to provide an electric energy to the auxiliary elements of the electric vehicle and make the auxiliary elements generate motion.

4. A power output control system for electric vehicle with hybrid fuel cell according to claim 1, wherein the system is further arranged a fuel cell that may output an electric energy after reactive operation.

5. A power output control system for electric vehicle with hybrid fuel cell according to claim 4, wherein the fuel cell is a polymer electrolyte membrane fuel cell.

6. A power output control system for electric vehicle with hybrid fuel cell according to claim 5, wherein the polymer electrolyte membrane fuel may be served as an on-board charger to make a charging action on the high power secondary battery.

7. A power output control system for electric vehicle with hybrid fuel cell according to claim 1, wherein the DC/DC converter may be further served as a regulator among the fuel cell, the higher power secondary fuel battrey, and the electric energy driving system.

8. A power output control system for electric vehicle with hybrid fuel cell according to claim 1, wherein the DC/DC converter may adjust the widely varied voltage (25% variation) into the voltage (10% variation) suitable for the electric energy driving system.

9. A power output control system for electric vehicle with hybrid fuel cell, which includes:
a hydrogen supplier, which is used to control the supplication of fuel;
a fuel cell, which may output an elec an elecgy after reactive operation;
an electric energy driving system, which is an electric motor that takes the DC power as energy source and may output power to the transmission apparatus;
a DC/DC converter, which changes the voltage and current of the electric energy output from the fuel cell and then outputs it to the electric energy driving system;
a high power secondary battery, which may output an electric energy to the electric energy driving system;
a fuel cell electric energy management unit, which may control the output flow path of the electric energy to make the various equipment required electric energy in the electric vehicle obtain appropriate electric energy;
a controller area network, which may be connected with the electric energy driving system, the high power secondary battery, and the fuel cell electric energy management unit and may adjust the electric energy output within a specific range according to the requirement of load; and
a fuel cell auxiliary system, which may provide an electric energy to the auxiliary elements of the electric vehicle and make the auxiliary elements generate motion.

10. A power output control system for electric vehicle with hybrid fuel cell according to claim 9, wherein the fuel cell is a polymer electrolyte membrane fuel cell.

11. A power output control system for electric vehicle with hybrid fuel cell according to claim 9, wherein the high power secondary battery may be formed by a plurality of lithium cells connected in serials.

12. A power output control system for electric vehicle with hybrid fuel cell according to claim 9, wherein the polymer electrolyte membrane fuel may be served as an on-board charger to make a charging action on the high power secondary battery.

13. A power output control system for electric vehicle with hybrid fuel cell according to claim 9, wherein the DC/DC converter may be further served as a regulator among the fuel cell, the higher power secondary fuel battery, and the electric energy driving system.

14. A power output control system for electric vehicle with hybrid fuel cell according to claim 9, wherein the DC/DC converter may adjust the widely varied voltage (25% variation) output from the fuel cell into the voltage (10% variation) suitable for the electric energy driving system.
